(19) United States
(12) Patent Application Publication
(10) Pub. No.: US 2024/0088345 A1
(43) Pub. Date: Mar. 14, 2024

(54) MANUFACTURING METHOD AND MANUFACTURING APPARATUS OF ELECTRODE STRUCTURE

(71) Applicant: KABUSHIKI KAISHA TOSHIBA, Tokyo (JP)

(72) Inventors: Yuta KANAI, Yokohama Kanagawa (JP); Hirofumi YASUMIISHI, Kawasaki Kanagawa (JP); Kazuomi YOSHIMA, Yokohama Kanagawa (JP); Tetsuya SASAKAWA, Yokohama Kanagawa (JP)

(73) Assignee: KABUSHIKI KAISHA TOSHIBA, Tokyo (JP)

(21) Appl. No.: 18/172,292

(22) Filed: Feb. 21, 2023

(30) Foreign Application Priority Data
Sep. 13, 2022 (JP) 2022-145577

(51) Int. Cl. H01M 4/04; H01M 10/04

(52) U.S. Cl. CPC H01M 4/0435; H01M 10/0404

(57) ABSTRACT

In a manufacturing method of an electrode structure of an embodiment, in a belt-like member in which an uncoated region not coated with an active material-containing layer is formed in one of a pair of long edges and its vicinity in a current collector, the active material-containing layer is rolled, and a tension in a longitudinal direction is applied to the belt-like member between a pulling unit pulling the belt-like member and a rolling unit rolling the active material-containing layer. In the method, between the rolling unit and the pulling unit, a pair of holding members are brought into contact with the uncoated region from opposite sides in a thickness direction of the belt-like member to which the tension is applied, thereby holding the uncoated region between the holding members.

### CROSS-REFERENCE TO RELATED APPLICATIONS

This application is based upon and claims the benefit of priority from prior Japanese Patent Application No. 2022-145577, filed Sep. 13, 2022; the entire contents of which are incorporated herein by reference.

### FIELD

Embodiments described herein relate generally to a manufacturing method and a manufacturing apparatus of an electrode structure.

### BACKGROUND

In a battery such as a secondary battery, an electrode such as a positive electrode or a negative electrode is formed by an electrode structure. The electrode structure includes a current collector, and an active material-containing layer applied on the surface of the current collector. The current collector includes a pair of long edges formed along the longitudinal direction. In the current collector of the electrode structure, an uncoated region in which neither of a pair of principal surfaces is coated with the active material-containing layer is formed in one of the pair of long edges and its vicinity. In the manufacture of the electrode structure like this, the surface of the current collector is coated with the active material-containing layer in a state in which the uncoated region not coated with the active material-containing layer is formed in one of the pair of long edges and its vicinity in the current collector. After the active material-containing layer applied on the current collector is dried, the active material-containing layer is rolled by a roll press or the like while a belt-like member in which the current collector is coated with the active material-containing layer is conveyed.

In the manufacture of the electrode structure, the active material-containing layer is rolled as described above, and the pressure of rolling is applied to a coated region in which at least one of the pair of principal surfaces is coated with the active material-containing layer in the current collector, so the current collector is enlarged in the longitudinal direction. On the other hand, the pressure of rolling is not applied to the uncoated region of the current collector, so the current collector is not enlarged in the longitudinal direction. Consequently, the rolling of the active material-containing layer curves the conveyed belt-like member (current collector) such that a side on which the uncoated region is positioned is the inside of the curve.

In the manufacture of the electrode structure, the curve of the belt-like member produced by the rolling of the active material-containing layer is corrected. In this correction of the belt-like member, the belt-like member is pulled toward the downstream side, on the downstream side of a rolling unit for rolling the active material-containing layer, thereby applying a tension in the longitudinal direction to the belt-like member between a pulling unit for pulling the belt-like member and the rolling unit. Then, for example, the uncoated region of the current collector in the belt-like member to which the tension is applied is pushed by a projection formed in the outer peripheral surface of a guide roller for guiding the belt-like member between the rolling unit and the pulling unit, thereby enlarging the uncoated region in the longitudinal direction and correcting the curve.

Depending on a battery that uses the electrode formed by the electrode structure, it is necessary to increase the width of the uncoated region in the widthwise direction in the belt-like member. In the manufacture of an electrode structure in which the width of the uncoated region is large, the enlarging amount in the longitudinal direction sometimes becomes uneven in the uncoated region during the correction of the curve of the belt-like member produced by the rolling of the active material-containing layer. For example, in the correction of the curve of the belt-like member, the enlarging amount in the longitudinal direction in a portion far from the active material-containing layer sometimes becomes smaller than that in a portion near the active material-containing layer in the uncoated region. Since the enlarging amount in the longitudinal direction becomes uneven in the uncoated region during the correction of the curve, the uncoated region becomes easily foldable. In the manufacture of an electrode structure in which the width of the uncoated region is large, it is required to appropriately suppress folding of the uncoated region after the active material-containing layer is rolled and the curve of the belt-like member is corrected.

### BRIEF DESCRIPTION OF THE DRAWINGS

FIG. 1 is a schematic view showing an example of an electrode structure formed in an embodiment, in a state in which the electrode structure is viewed from one side in the thickness direction.

FIG. 2 is a sectional view schematically showing a section of the electrode structure shown in FIG. 1, which is perpendicular to or almost perpendicular to the longitudinal direction.

FIG. 3 is a schematic view showing an example of a manufacturing apparatus for manufacturing an electrode structure in the embodiment.

FIG. 4 is a sectional view schematically showing an example of the configuration of an enlarging unit in the manufacturing apparatus according to the embodiment, by a section perpendicular to or almost perpendicular to the conveyance direction in a conveyance unit.

FIG. 5 is a sectional view schematically showing an example of the configuration of a holding unit in the manufacturing apparatus according to the embodiment, by a section perpendicular to or almost perpendicular to the conveyance direction in the conveyance unit.

FIG. 6 is a schematic view showing the holding unit in FIG. 5 in a state in which the holding unit is viewed in a direction crossing both the conveyance direction in the conveyance unit and the widthwise direction of the conveyance unit.

FIG. 7 is a sectional view schematically showing the holding unit in FIG. 5, by a section perpendicular to or almost perpendicular to the widthwise direction of the conveyance unit.

FIG. 8 is a sectional view schematically showing the configuration of a holding unit in a manufacturing apparatus according to a modification, by a section perpendicular to or almost perpendicular to the conveyance direction in a conveyance unit.

### DETAILED DESCRIPTION

In a manufacturing method of an electrode structure of an embodiment, a belt-like member, in which the surface of a current collector is coated with an active material-containing layer and an uncoated region not coated with the active material-containing layer is formed in one of a pair of long edges along the longitudinal direction and its vicinity in the current collector, is conveyed. In this manufacturing method, the active material-containing layer is rolled, and the belt-like member is pulled toward the downstream side, on the downstream side of a rolling unit for rolling the active material-containing layer, thereby applying a tension in the longitudinal direction to the belt-like member between a pulling unit for pulling the belt-like member and the rolling unit. In the manufacturing method, between the rolling unit and the pulling unit, a pair of holding members are brought into contact with the uncoated region of the current collector from opposite sides in the thickness direction of the belt-like member to which the tension is applied, thereby holding the uncoated region between the pair of holding members.

The embodiment and the like will be explained below with reference to the accompanying drawings.

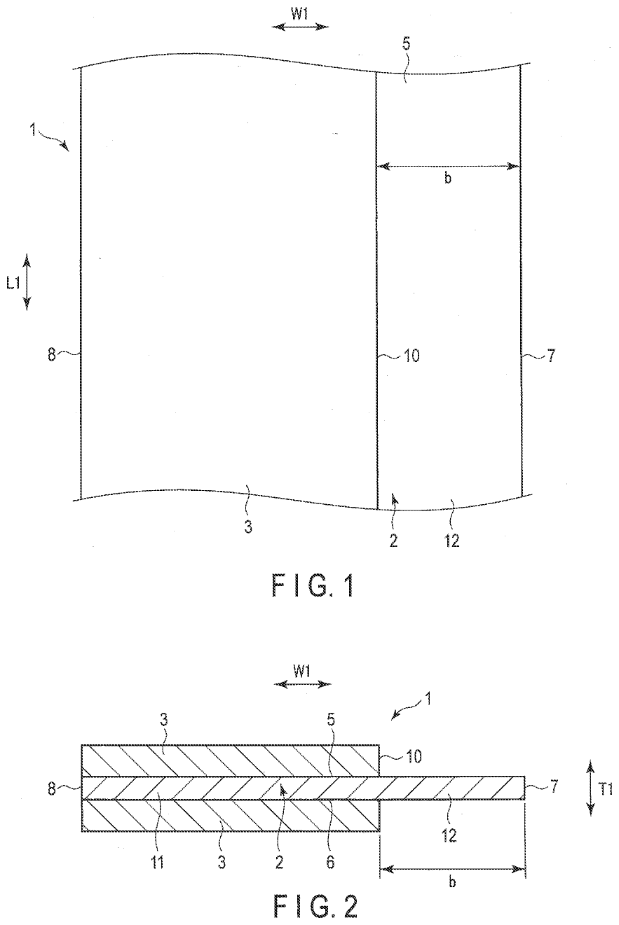

The embodiment provides a manufacturing method and a manufacturing apparatus of an electrode structure. An electrode structure manufactured in the embodiment is used in the formation of a positive electrode or a negative electrode in a battery such as a secondary battery. FIGS. 1 and 2 show an example of an electrode structure 1 manufactured in the embodiment. In the electrode structure 1 as shown in FIGS. 1 and 2, a longitudinal direction (a direction indicated by an arrow L1), a widthwise direction (a direction indicated by an arrow W1) crossing (perpendicular to or almost perpendicular to) the longitudinal direction, and a thickness direction (a direction indicated by an arrow T1) crossing (perpendicular to or almost perpendicular to) both the longitudinal direction and the widthwise direction, are defined. FIG. 1 shows a state viewed from one side of the thickness direction, and FIG. 2 shows a section perpendicular to or almost perpendicular to the longitudinal direction. In the electrode structure 1, a dimension in the longitudinal direction is larger than dimensions in the widthwise direction and the thickness direction, and the dimension in the widthwise direction is larger than the dimension in the thickness direction.

In one example, the electrode structure 1 is used as the positive electrode or the negative electrode of a battery such as a lithium-ion secondary battery. In another example, the electrode structure 1 is divided into a plurality of electrode sheets in the longitudinal direction. Then, each of the plurality of electrode sheets is used as a positive electrode or a negative electrode. The electrode structure 1 includes a current collector 2, and active material-containing layers 3 applied on surfaces of the current collector 2. The current collector 2 is made of a metal having conductivity, and includes a pair of principal surfaces 5 and 6, and a pair of long edges 7 and 8. Each of the principal surfaces 5 and 6 and the long edges 7 and 8 is extended along the longitudinal direction, and extended from one end to the other end of the electrode structure 1 in the longitudinal direction. Also, each of the principal surfaces 5 and 6 is extended from the long edge 7 to the long edge 8 in the widthwise direction of the electrode structure 1. The principal surface 5 faces one side in the thickness direction of the electrode structure 1, and the principal surface 6 faces the side opposite to the principal surface 5 in the thickness direction of the electrode structure 1.

The long edge (first long edge) 7 forms an edge on one side of the current collector 2 in the widthwise direction of the electrode structure 1. The long edge (second long edge) 8 forms an edge on the side opposite to the long edge 7 of the current collector 2 in the widthwise direction of the electrode structure 1. The active material-containing layer 3 is extended from one end to the other end of the electrode structure 1 in the longitudinal direction. Also, the active material-containing layer 3 is extended from the long edge 8 of the current collector 2 to a coating end 10 in the widthwise direction of the electrode structure 1. The end opposite to the coating end 10 of the active material-containing layer 3 in the widthwise direction of the electrode structure 1 overlaps the long edge 8 of the current collector 2 when viewed in the thickness direction. The coating end 10 is positioned on a side where the long edge 7 is positioned, with respect to the central position of the electrode structure 1 in the widthwise direction. Accordingly, the dimension between the long edge 8 and the coating end 10 in the widthwise direction of the electrode structure 1 is larger than the dimension between the long edge 7 and the coating end 10 in the widthwise direction of the electrode structure 1.

In this example shown in FIGS. 1 and 2, a coated region 11 where the active material-containing layers 3 are applied on and supported by both of the pair of principal surfaces 5 and 6 of the current collector 2 is formed between the long edge 8 and the coating end 10 in the widthwise direction of the electrode structure 1. In addition, an uncoated region 12 where the active material-containing layer 3 is not coated on or supported by either of the pair of principal surfaces 5 and 6 of the current collector 2 is formed between the long edge 7 and the coating end 10 in the widthwise direction of the electrode structure 1. In the current collector 2, therefore, the uncoated region 12 where the active material-containing layer 3 is not formed on either of the pair of principal surfaces 5 and 6 is formed in the long edge 7 and its vicinity in the current collector 2. In the electrode structure 1, the uncoated region 12 protrudes from the coating end 10 of the active material-containing layer 3 to the side opposite to the side where the long edge 8 is positioned in the widthwise direction. Note that in one example, the active material-containing layer 3 is supported by only one of the pair of principal surfaces 5 and 6 of the current collector 2 in the coated region 11. In the coated region 11, therefore, the active material-containing layer 3 need only be applied on and supported by at least one of the pair of principal surfaces 5 and 6 of the current collector 2.

In a case where the electrode structure 1 is used to form a positive electrode, the current collector 2 is formed by one of, for example, aluminum, an aluminum alloy, stainless steel, and titanium, although the material is not limited to them, and has a thickness of about 10 μm to 30 μm. The active material-containing layer 3 includes a positive electrode active material, and can also include a binder and an electro-conductive agent. Examples of the positive electrode active material are an oxide, a sulfide, and a polymer, each of which can occlude and release lithium ions, although the material is not limited to them. The positive electrode active material contains, for example, at least one selected from the group consisting of a lithium-manganese composite oxide, a lithium-nickel composite oxide, a lithium-cobalt-aluminum composite oxide, a lithium-nickel-cobalt-manganese composite oxide, a spinel lithium-manganese-nickel composite oxide, a lithium-manganese-cobalt oxide, a lithium-iron oxide, lithium fluorinated iron sulfate, a lithium-iron composite phosphate compound, and a lithium-manganese composite phosphate compound.

One or more types of carbonaceous materials are used as the electro-conductive agent. Examples of the carbonaceous materials to be used as the electro-conductive agent are acetylene black, Ketjenblack, graphite, and coke. Also, a polymer resin or the like is used as the binder. The binder contains, for example, at least one selected from the group consisting of polytetrafluoroethylene (PTFE), polyvinylidene fluoride (PVdF), fluorine-based rubber, styrene-butadiene rubber, ethylene-butadiene rubber, polypropylene (PP), polyethylene (PE), carboxymethylcellulose (CMC), polyimide (PI), and polyacrylimide (PAI). The positive electrode active material-containing layer can also include an inorganic solid electrolyte.

Inorganic solid particles are blended in order to increase the lithium ion conductivity of the active material-containing layer. The inorganic solid particles preferably contain at least one type of a compound selected from the group consisting of a metal oxide and a lanthanoid-based oxide containing at least one type of an element selected from the group consisting of Ti, Ge, Sr, Zr, Sn, Al, Sc, Y, Ba, P, and Ca, and a sulfide containing at least one type of an element selected from the group consisting of Li, Ge, P, Si, Sn, Al, Ga, B, and In. The lanthanoid-based oxide is an oxide containing lanthanoid elements such as La, Ce, Pr, and Nd. Note that the above-described metal oxide can further contain a lanthanoid element such as La.

Examples of the inorganic solid particles are an oxide-based solid electrolyte and a sulfide-based solid electrolyte. As the oxide-based solid electrolyte, it is favorable to use a lithium phosphate solid electrolyte having a NASICON (Sodium (Na) Super Ionic Conductor) structure and represented by formula LiM₂(PO₄)₃. In this formula, M is, for example, at least one type of an element selected from the group consisting of titanium (Ti), germanium (Ge), strontium (Sr), zirconium (Zr), tin (Sn), aluminum (Al), and calcium (Ca). The ion conductivity of the lithium phosphate solid electrolyte represented by formula LiM₂(PO₄)₃ is, for example, 1×10⁻⁵ S/cm or more to 1×10⁻³ S/cm or less.

Practical examples of the lithium phosphate solid electrolyte having the NASICON structure are LATP (Li_{1+x+y}Alₓ(at least one of Ti and Ge)₂₋ₓSi_{y}P_{3-y}O₁₂; 0<x≤2, 0≤y<3), Li₁₊ₓAlₓGe₂₋ₓ(PO₄)₃; 0≤x≤2, and Li₁₊ₓAlₓZr₂₋ₓ(PO₄)₃; 0≤x≤2, Li₁₊₂ₓZr₁₋ₓCaₓ(PO₄)₃; 0≤x<1. Li₁₊₂ₓZr₁₋ₓCaₓ(PO₄)₃ has a high water resistance, a low reducibility, and a lost cost, and hence is preferably used as the inorganic solid electrolyte particles.

In addition to the abovementioned lithium phosphate solid electrolyte, examples of the oxide-based solid electrolyte are amorphous LIPON (Li_{2.9}PO_{3.3}N_{0.46}), La₅₊ₓAₓLa₃₋ₓM₂O₁₂ (A is at least one type selected from the group consisting of Ca, Sr, and Ba, and M is at least one of Nb and Ta) having a garnet structure, Li₃M₂₋ₓL₂O₁₂ (M is at least one of Ta and Nb, and L is Zr), Li₇₋₃ₓAlₓLa₃Zr₃O₁₂, and LLZ (Li₇La₃Zr₂O₁₂). It is possible to use either one type of a solid electrolyte or two or more types of solid electrolytes by mixing them. The ion conductivity of LIPON is, for example, 1×10⁻⁶ S/cm or more to 5×10⁻⁶ S/cm or less. The ion conductivity of LLZ is, for example, 1×10⁻⁴ S/cm or more to 5×10⁻⁴ S/cm or less.

In a case where the electrode structure 1 is used to form a negative electrode, the current collector 2 is formed by one of, for example, zinc, aluminum, an aluminum alloy, and copper, although the material is not limited to them, and has a thickness of about 10 μm to 30 μm. The negative electrode active material-containing layer includes a negative electrode active material, and can also include a binder and an electro-conductive agent. The negative electrode active material is not particularly limited, and examples are a metal oxide, a metal sulfide, a metal nitride, and a carbonaceous material, each of which can occlude and release lithium ions. An example of the metal oxide usable as the negative electrode active material is a titanium-containing oxide. Examples of the titanium-containing oxide usable as the negative electrode active material are titanium oxide, lithium titanium oxide, niobium titanium oxide, and sodium niobium titanium oxide. Examples of the electro-conductive agent and the binder are the same materials as those used in the formation of the positive electrode. Also, the negative electrode active material-containing layer can include an inorganic solid electrolyte in the same manner as in the formation of a positive electrode. Examples of the inorganic solid electrolyte are the same materials as those used in the formation of a positive electrode.

In the manufacture of the electrode structure 1, the active material to be used as the positive electrode active material or the negative electrode active material, the electro-conductive agent, and the binder are suspended in an organic solvent or pure water, thereby preparing a slurry. In this case, the blending ratio of the active material is preferably 70 mass % or more to 95 mass % or less, that of the electro-conductive agent is preferably 2 mass % or more to 20 mass % or less, and that of the binder is preferably 2 mass % or more to 10 mass % or less. The prepared slurry was applied on the surfaces of the current collector 2, thereby forming a belt-like member in which the surfaces of the current collector 2 are coated with active material-containing layers 3. Coating of the slurry is performed by using a coating head or the like.

In the manufacture of the electrode structure 1, the electrode structure 1 is formed by performing steps to be described later on the belt-like member formed as described above. In the belt-like member, the longitudinal direction, the widthwise direction, and the thickness direction are defined, and the coated region 11 and the uncoated region 12 are formed, in the same manner as in the electrode structure 1. In the belt-like member, therefore, the uncoated region 12 where neither of the pair of principal surfaces 5 and 6 is coated with the active material-containing layer 3 is formed in the long edge 7 and its vicinity in the current collector 2. Also, in the belt-like member, the coated region 11 where at least one of the pair of principal surfaces 5 and 6 is coated with the active material-containing layer 3 is formed from the long edge 8 of the current collector 2 to the coating end 10 of the active material-containing layer 3 in the widthwise direction. In the manufacture of the electrode structure 1, after the current collector 2 is coated with the active material-containing layers 3, the active material-containing layers 3 (slurry) applied on the surfaces of the current collector 2 are dried.

Depending on a battery that uses the electrode formed from the electrode structure 1, it is necessary to increase a width b of the uncoated region 12 in the widthwise direction in the belt-like member. In one example, the current collector 2 is coated with the active material-containing layers 3 such that the width b of the uncoated region 12 in the widthwise direction of the belt-like member (current collector 2) becomes larger than 25 mm. In this case, in the manufactured electrode structure 1, the width b of the uncoated region 12 in the widthwise direction is larger than 25 mm. However, even in a case where the width b of the uncoated region 12 in the widthwise direction of the belt-like member is larger than 25 mm, the dimension of the coated region 11 in the widthwise direction is larger than the width b of the uncoated region 12 in the widthwise direction.

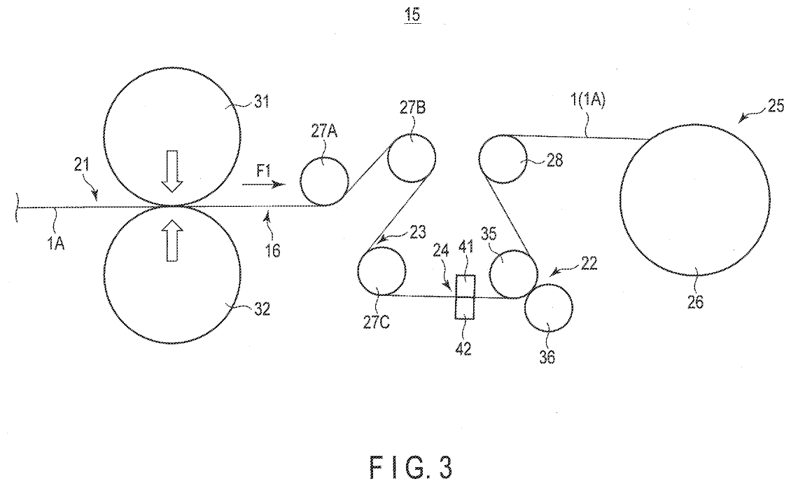

FIG. 3 shows an example of a manufacturing apparatus 15 for manufacturing the electrode structure 1. FIG. 3 shows a step after the active material-containing layers 3 applied on the current collector 2 are dried in the manufacture of the electrode structure 1. The manufacturing apparatus 15 in the example shown in FIG. 3 includes a conveyance unit 16. In the conveyance unit 16, a belt-like member 1A, in which the current collector 2 is coated with the active material-containing layers 3 and the applied active material-containing layers 3 are dried, is conveyed. In the conveyance unit 16, a conveyance direction (a direction indicated by an arrow F1) and a widthwise direction crossing (perpendicular to or almost perpendicular to) the conveyance direction are defined. Referring to FIG. 3, a direction perpendicular to or almost perpendicular to the paper surface is the widthwise direction of the conveyance unit 16. Also, in the conveyance unit 16, a side on which the belt-like member 1A is conveyed is the downstream side, and a side opposite to the side on which the belt-like member 1A is conveyed is the upstream side. In the conveyance unit 16, the belt-like member 1A is conveyed such that the longitudinal direction of the belt-like member 1A is taken along the conveyance direction, and the widthwise direction of the belt-like member 1A is taken along the widthwise direction of the conveyance unit 16. Accordingly, in the belt-like member 1A conveyed in the conveyance unit 16, the thickness direction of the belt-like member 1A crosses (is perpendicular to or almost perpendicular to) both the conveyance direction and the widthwise direction of the conveyance unit 16.

The manufacturing apparatus 15 of the example shown in FIG. 3 includes a rolling unit 21, a pulling unit 22, an enlarging unit 23, a holding unit 24, and a take-up unit 25. In the manufacturing apparatus 15, the belt-like member 1A in which the active material-containing layers 3 are dried is conveyed into the rolling unit 21. Then, the belt-like member 1A is conveyed from the rolling unit 21 to the take-up unit 25 by being passed through the enlarging unit 23, the holding unit 24, and the pulling unit 22 in this order. The rolling unit 21, the enlarging unit 23, the holding unit 24, and the pulling unit 22 perform steps to be described later on the conveyed belt-like member 1A, thereby forming the electrode structure 1. The take-up unit 25 takes up the conveyed belt-like member 1A, that is, the formed electrode structure 1. In this example shown in FIG. 3, the take-up unit 25 includes a take-up reel 26, and the take-up reel 26 takes up the electrode structure 1 (the belt-like member 1A) in the form of a roll. Also, in the example shown in FIG. 3, three guide rollers (rollers) 27A, 27B, and 27C guide the belt-like member 1A from the upstream side to the downstream side in the conveyance unit 16, between the rolling unit 21 and the holding unit 24. In addition, a guide roller 28 guides the belt-like member 1A from the upstream side to the downstream side between the pulling unit 22 and the take-up unit 25. Each of the guide rollers 27A to 27C and 28 is made of a metal such as iron or stainless steel.

The rolling unit 21 rolls the active material-containing layer 3 in the conveyed belt-like member 1A by using a roll press or the like. The rolling unit 21 includes a pair of press rollers 31 and 32, and each of the press rollers 31 and 32 is made of a metal such as iron or stainless steel. The press roller 31 presses the active material-containing layer 3 from one side in the thickness direction of the belt-like member 1A, and the press roller 32 presses the active material-containing layer 3 from the side opposite to the press roller 31, in the thickness direction of the belt-like member 1A. Consequently, the active material-containing layer 3 is sandwiched between the press rollers 31 and 32 in the thickness direction of the belt-like member 1A, and a pressure (press pressure) is applied to the active material-containing layer 3 in the thickness direction of the belt-like member 1A. In a case where the both surfaces of the current collector 2 are coated with the active material-containing layers 3, the active material-containing layers 3 are pressed in a state in which the press rollers 31 and 32 are in contact with the active material-containing layers 3. In a case where only one surface of the current collector 2 is coated with the active material-containing layer 3, the active material-containing layer 3 is pressed in a state in which one of the press rollers 31 and 32 is in contact with the active material-containing layer 3, and the other one of the press rollers 31 and 32 is in contact with the coated region 11 of the current collector 2. The pressure from the press rollers 31 and 32 compresses the active material-containing layer 3 in the thickness direction of the belt-like member 1A, and enlarges the active material-containing layer 3 in the longitudinal direction of the belt-like member 1A.

The pressure for rolling the active material-containing layer 3 is also applied to the coated region 11 coated with the active material-containing layer 3 on at least one of the pair of principal surfaces 5 and 6 in the current collector 2. In the coated region 11, therefore, the pressure for rolling the active material-containing layer 3 enlarges (extends) the current collector 2 in the longitudinal direction. On the other hand, the press rollers 31 and 32 do not apply any pressure for rolling the active material-containing layer 3 to the uncoated region 12 of the current collector 2. In the rolling of the active material-containing layer 3, therefore, the uncoated region 12 of the current collector 2 is not enlarged in the longitudinal direction. Since the current collector 2 is enlarged in the longitudinal direction in only the coated region 11 as described above, the rolling of the active material-containing layer 3 curves the conveyed belt-like member 1A (the current collector 2) in a state in which the side where the uncoated region 12 is positioned is the inside of the curve.

In this embodiment, the pulling unit 22 and the enlarging unit 23 correct the curve of the belt-like member 1A (the current collector 2) produced by the rolling of the active material-containing layer 3. The pulling unit 22 is installed on the downstream side of the conveyance unit 16 with respect to the rolling unit 21, and pulls the belt-like member 1A toward the downstream side. That is, the pulling unit 22 pulls the belt-like member 1A to the side where the take-up unit 25 is positioned. The pulling unit 22 includes a pair of pulling rollers 35 and 36. Each of the pulling rollers 35 and 36 is made of rubber or the like, and the friction coefficient of the pulling rollers 35 and 36 is larger than those of the guide rollers 27A to 27C and 28 and the press rollers 31 and 32.

In the pulling unit 22, the pulling roller 35 abuts against the belt-like member 1A from one side in the thickness direction, and the pulling roller 36 abuts against the belt-like member 1A from the side opposite to the pulling roller 35 in the thickness direction. In the pulling unit 22, therefore, the belt-like member 1A is pulled to the downstream side of the conveyance unit 16 in a state in which the belt-like member 1A is sandwiched between the pulling rollers 35 and 36. Since the pulling unit 22 pulls the belt-like member 1A to the downstream side, a tension in the longitudinal direction is applied to the belt-like member 1A (the current collector 2) between the pulling unit 22 and the rolling unit 21. Between the pulling unit 22 and the roller unit 21, therefore, the belt-like member 1A to which the tension in the longitudinal direction is applied is conveyed through the guide rollers 27A to 27C.

In the conveyance unit 16, the enlarging unit 23 and the holding unit 24 are arranged between the rolling unit 21 and the pulling unit 22, and the enlarging unit 23 is installed between the rolling unit 21 and the holding unit 24. In the example shown in FIG. 3, the guide roller 27C forms the enlarging unit 23. Note that the enlarging unit 23 is formed by the guide roller 27C in the following explanation, but the enlarging unit 23 can also be formed by one of the guide rollers 27A and 27B. That is, between the rolling unit 21 and the pulling unit 22, the enlarging unit 23 need only be formed by a roller, such as a guide roller, which is used to convey the belt-like member 1A. In either case, the configuration of the enlarging unit 23, the processing by the enlarging unit 23, and the like are the same as in a case where the enlarging unit 23 is formed by the guide roller 27C.

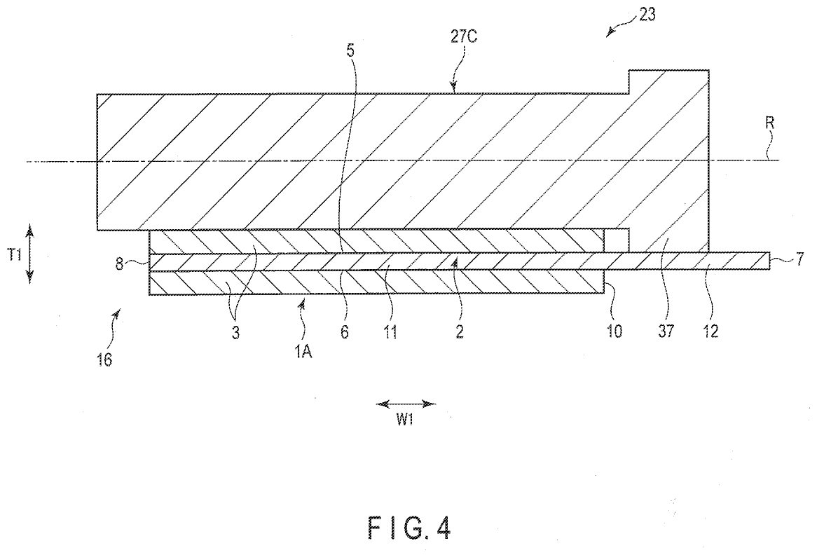

FIG. 4 shows an example of the configuration of the enlarging unit 23. FIG. 4 shows a section perpendicular to or almost perpendicular to the conveyance direction in the conveyance unit 16, and shows the belt-like member 1A conveyed in the conveyance unit 16 by a section perpendicular to or almost perpendicular to the longitudinal direction. In this example shown in FIG. 4, the enlarging unit 23 includes the guide roller (roller) 27C, and the guide roller 27C has a rotational axis (central axis) R. The guide roller 27C can rotate around the rotational axis R. In the guide roller 27C, an axial direction taken along the rotational axis R and a circumferential direction as a direction around the rotational axis R are defined. In the conveyance unit 16, the belt-like member 1A is conveyed in a state in which the rotational axis R of the guide roller 27C is taken along the widthwise direction of the belt-like member 1A. Accordingly, the axial direction of the guide roller 27C matches or almost matches the widthwise direction of the conveyance unit 16.

The enlarging unit 23 includes a projection 37 formed on the outer peripheral portion of the guide roller 27C. On the outer peripheral portion of the guide roller 27C, the projection 37 projects toward the outer peripheral side. Also, the projection 37 is formed over the entire circumference in the circumferential direction of the guide roller 27C (the direction around the rotational axis R). In the guide roller 27C, the projection 37 is formed in one end portion in the axial direction. Note that FIG. 4 shows the guide roller 27C by a section parallel to or almost parallel to the axial direction (the rotational axis R).

In a state in which the belt-like member 1A is conveyed through the guide roller 27C, the projection 37 is formed on a side where the long edge 7 is positioned, with respect to the coating end 10 of the active material-containing layer 3, in the widthwise direction of the belt-like member 1A. That is, the projection 37 is formed on a side where the uncoated region 12 projects, with respect to the coating end 10 of the active material-containing layer 3, in the axial direction of the guide roller 27B. The projection 37 abuts against the uncoated region 12 of the current collector 2 from one side in the thickness direction, relative to the belt-like member 1A to which a tension is applied in the longitudinal direction by the pulling unit 22, and pushes the uncoated region 12 from one side in the thickness direction. Since the uncoated region 12 is pushed by the projection 37 with the tension being applied, the current collector 2 in the uncoated region 12 is enlarged (extended) in the longitudinal direction by the pressure from the projection 37.

In a state in which the belt-like member 1A is conveyed through the enlarging unit 23, as described above, the projection 37 is positioned on a side where the uncoated region 12 projects with respect to the coating end 10 of the active material-containing layer 3, in the widthwise direction of the belt-like member 1A. Accordingly, the projection 37 does not abut against the coated region 11 of the current collector 2 and the active material-containing layer 3, and does not push the coated region 11 of the current collector 2. In the enlarging unit 23, therefore, the coated region 11 of the current collector 2 is not enlarged in the longitudinal direction.

In this embodiment as described above, the current collector 2 is enlarged in the longitudinal direction in only the uncoated region 12 by pushing only the uncoated region 12 by the projection 37 in a state in which the tension in the longitudinal direction acts on the belt-like member 1A (the current collector 2). Since the current collector 2 is enlarged in the longitudinal direction in only the uncoated region 12, the above-described curve produced by the rolling of the active material-containing layer 3 is corrected. Note that in a case where only one of the pair of principal surfaces 5 and 6 is coated with the active material-containing layer 3 in the coated region 11, the projection 37 pushes the uncoated region 12 from a side toward which the principal surface (a corresponding one of 5 and 6) to be coated with the active material-containing layer 3 faces, in the thickness direction of the belt-like member 1A.

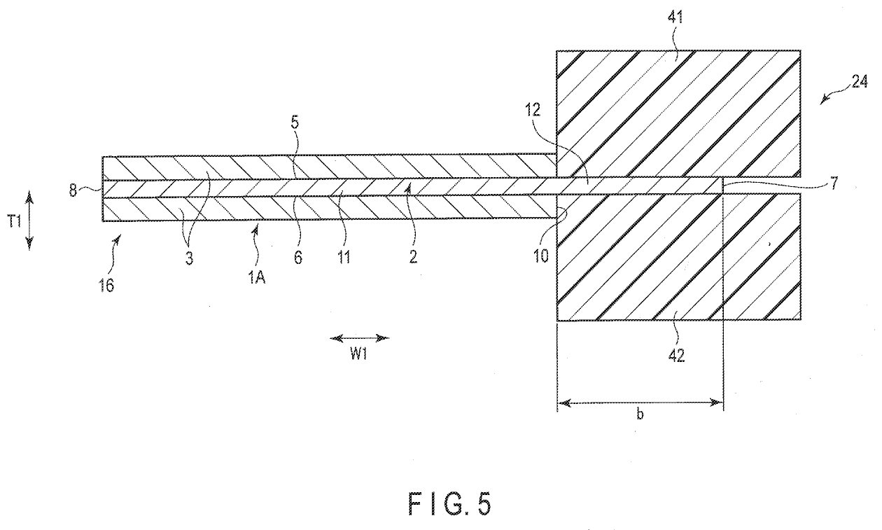

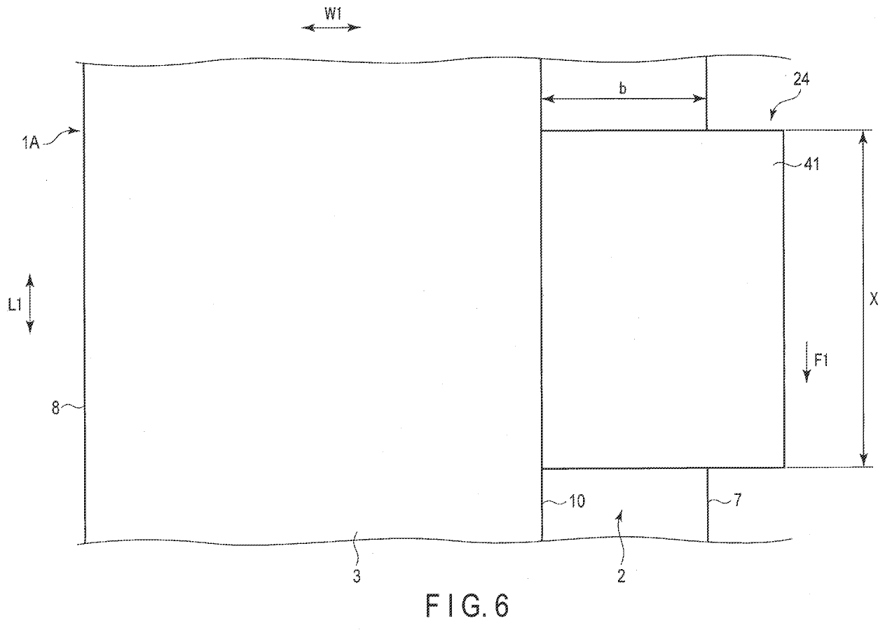

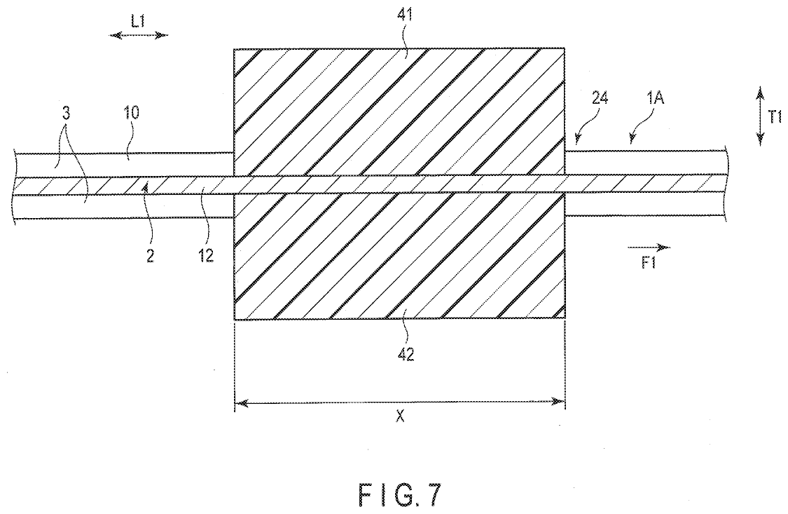

FIGS. 5, 6, and 7 illustrate an example of the configuration of the holding unit 24. FIG. 5 shows a section perpendicular to or almost perpendicular to the conveyance direction in the conveyance unit 16, and shows the belt-like member 1A conveyed in the conveyance unit 16 by a section perpendicular to or almost perpendicular to the longitudinal direction. FIG. 6 shows a state viewed in a direction crossing both the conveyance direction in the conveyance unit 16 and the widthwise direction of the conveyance unit 16, and shows the belt-like member 1A viewed from one side in the thickness direction. FIG. 7 shows a section perpendicular to or almost perpendicular to the widthwise direction of the conveyance unit 16, and shows the belt-like member 1A by a section perpendicular to or almost perpendicular to the widthwise direction and passing through the uncoated region 12.

As shown in FIGS. 5, 6, and 7, the holding unit 24 includes a pair of holding members 41 and 42. The holding members 41 and 42 are aligned or almost aligned with each other in the conveyance direction in the conveyance unit 16 and the widthwise direction of the conveyance unit 16. Also, in a state in which the belt-like member 1A is conveyed through the holding unit 24, the pair of holding members 41 and 42 oppose each other with the uncoated region 12 of the current collector 2 being sandwiched between them. In the holding unit 24, the holding member (first holding member) 41 comes in contact with the uncoated region 12 from one side in the thickness direction of the belt-like member 1A. The holding member (second holding member) 42 comes in contact with the uncoated region 12 from the side opposite to the holding member 41 in the thickness direction of the belt-like member 1A. That is, the pair of holding members 41 and 42 come in contact with the uncoated region 12 of the current collector 2 in the belt-like member 1A to which the tension is applied, from the sides opposite to each other in the thickness direction of the belt-like member 1A. Consequently, the uncoated region 12 is held between the pair of holding members 41 and 42 in the holding unit 24.

Each of the holding members 41 and 42 is formed by, for example, polyethylene. The material forming the holding members 41 and 42 is softer than the materials such as iron and stainless steel forming the press rollers 31 and 32 and the guide rollers 27A to 27C and 28. The material forming the holding members 41 and 42 can be either softer or harder than the material forming the pulling rollers 35 and 36. Also, the material forming the holding members 41 and 42 can be as soft as the material forming the pulling rollers 35 and 36.

The friction coefficient of the holding members 41 and 42 is smaller than that of the pulling rollers 35 and 36. The friction coefficient of the holding members 41 and 42 can be either larger or smaller than those of the press rollers 31 and 32 and the guide rollers 27A to 27C and 28. Also, the friction coefficient of the holding members 41 and 42 can be either the same as or almost the same as those of the press rollers 31 and 32 and the guide rollers 27A to 27C and 28. In one example, the dynamic friction coefficient of the holding members 41 and 42 is 1 or less.

Each of the holding members 41 and 42 comes in surface contact with the uncoated region 12. In the example shown in FIGS. 5, 6, and 7, each of the holding members 41 and 42 comes in contact with the uncoated region 12 over the entire width or almost the entire width in the widthwise direction of the belt-like member 1A. That is, in the widthwise direction of the belt-like member 1A, each of the holding members 41 and 42 comes in contact with the uncoated region 12 of the current collector 2 over the whole range from the long edge 7 of the current collector 2 to the coating end 10 of the active material-containing layer 3. Also, in a state in which the belt-like member 1A is conveyed through the holding unit 24, the holding members 41 and 42 are arranged on a side where the long edge 7 is positioned, with respect to the central position of the belt-like member 1A, in the widthwise direction of the belt-like member 1A (the widthwise direction of the conveyance unit 16). Note that in the example shown in FIGS. 5, 6, and 7, each of the holding members 41 and 42 does not come in contact with the active material-containing layer 3 (the coated region 11) from the thickness direction of the belt-like member 1A.

In addition, the range within which the pair of holding members 41 and 42 come in contact with the uncoated region 12 is defined as a contact range. A dimension X of the contact range in the longitudinal direction of the belt-like member 1A is preferably twice or more the width b of the uncoated region 12 in the widthwise direction of the belt-like member 1A. Each of the holding members 41 and 42 can come in contact with the uncoated region 12 in a nonrotatable state, and can also come in contact with the uncoated region 12 in a state in which it can rotate around the rotational axis along the widthwise direction of the conveyance unit 16. However, the holding members 41 and 42 are preferably nonrotatable.

In the belt-like member 1A in which the width b of the uncoated region 12 in the widthwise direction of the current collector 2 is large, such as the belt-like member 1A in which the width b is larger than 25 mm, if the curve of the belt-like member 1A produced by the rolling of the active material-containing layer 3 is corrected by the pulling unit 22 and the enlarging unit 23 as described above, the enlarging amount in the longitudinal direction sometimes becomes uneven in the noncoated region 12. For example, during the correction of the curve of the belt-like member 1A, in the noncoated region 12, the enlarging amount in the longitudinal direction in a portion far from the active material-containing layer 3 (the coating end 10) sometimes becomes smaller than that in a portion close to the active material-containing layer 3. If the enlarging amount in the longitudinal direction in the uncoated region 12 becomes nonuniform during the correction of the curve, the uncoated region 12 becomes easily foldable.

In this embodiment, between the rolling unit 21 and the pulling unit 22, the pair of holding members 41 and 42 come in contact with the uncoated region 12 of the current collector 2 from opposite sides in the thickness direction of the belt-like member 1A, thereby holding the uncoated region 12 between them. Therefore, in the manufacture of an electrode structure in which the width b of the uncoated region 12 is large, even if the uncoated region 12 is made easily foldable by the rolling of the active material-containing layer 3 and the correction of the curve of the belt-like member 1A, the pair of holding members 41 and 42 hold the uncoated region 12 between them, thereby appropriately suppressing folding of the current collector 2 in the uncoated region 12.

Also, the dimension X of the contact range of the holding members 41 and 42 in the longitudinal direction of the belt-like member 1A is twice or more the width b of the uncoated region 12 in the widthwise direction of the belt-like member 1A. This increases the contact area between each of the holding members 41 and 42 and the uncoated region 12. This more appropriately suppresses folding of the current collector 2 in the uncoated region 12. In addition, the embodiment adopts at least one of the arrangement in which each of the holding members 41 and 42 comes in contact with the uncoated region 12 in a nonrotatable state, and the arrangement in which the holding members 41 and 42 come in contact with the coated region 12 over the entire width between the long edge 7 and the coating end 10 of the active material-containing layer 3. This further appropriately suppresses folding of the current collector 2 in the uncoated region 12.

Suppressing folding of the current collector 2 in the uncoated region 12 effectively prevents a damage or the like to the current collector 2 in a state in which the belt-like member 1A is conveyed on the downstream side of the holding unit 24. For example, it is possible to effectively prevent the current collector 2 from being rolled in to one of the pulling rollers 35 and 36 of the pulling unit 22.

Also, in this embodiment, the material forming the holding members 41 and 42 is softer than the materials forming the press rollers 31 and 32 and the guide rollers 27A to 27C and 28. Therefore, even if the holding members 41 and 42 hold the uncoated region 12 between them, it is possible to effectively prevent a damage or the like to the uncoated region 12 caused by the contact of the holding members 41 and 42. In addition, the friction coefficient of the holding members 41 and 42 is smaller than that of the pulling rollers 35 and 36. Accordingly, even if each of the holding members 41 and 42 comes in contact with the uncoated region 12, friction between each of the holding members 41 and 42 and the uncoated region 12 is properly reduced.

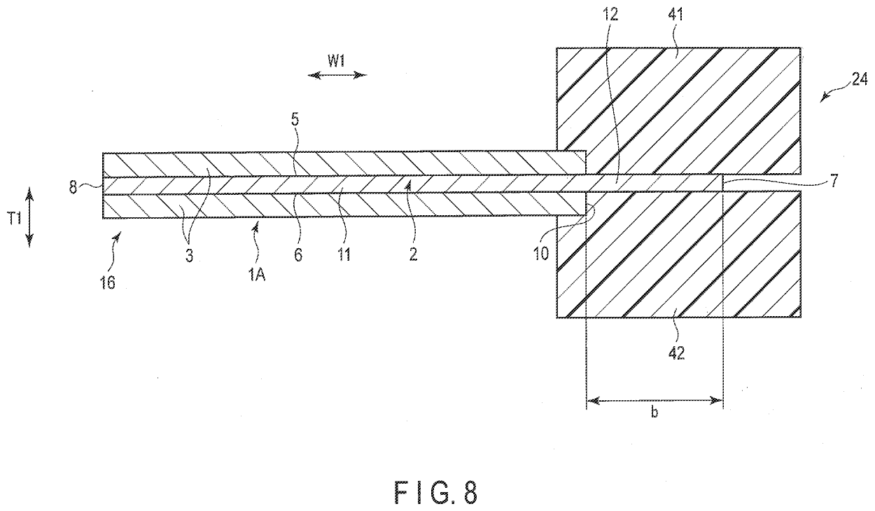

In a modification shown in FIG. 8, in the holding unit 24, each of the holding members 41 and 42 comes in contact with the uncoated region 12 of the current collector 2, and comes in contact with the active material-containing layer 3 as well. In this modification, in the active material-containing layer 3, each of the holding members 41 and 42 comes in contact with only the coating end 10 and its vicinity. In this example shown in FIG. 8, each of the holding members 41 and 42 comes in surface contact with the uncoated region 12, and comes in contact with the uncoated region 12 over the entire width or almost the entire width in the widthwise direction of the belt-like member 1A, in the same manner as in the example shown in FIGS. 5, 6, and 7. Since the material forming the holding members 41 and 42 is soft, that portion of each of the holding members 41 and 42, which comes in contact with the active material-containing layer 3, is compressed in the thickness direction of the belt-like member 1A. Note that FIG. 8 shows a section perpendicular to or almost perpendicular to the conveyance direction in the conveyance unit 16, and shows the belt-like member 1A conveyed in the conveyance unit 16 by a section perpendicular to or almost perpendicular to the longitudinal direction.

In another example, only one of the pair of principal surfaces 5 and 6 is coated with the active material-containing layer 3 in the coated region 11. In the holding unit 24, one of the holding members 41 and 42 comes in contact with the uncoated region 12 of the current collector 2, and comes in contact with the active material-containing layer 3 as well. In the active material-containing layer 3, one of the holding members 41 and 42 comes in contact with only the coating end 10 and its vicinity. The other one of the holding members 41 and 42 comes in contact with the uncoated region 12 of the current collector 2, and comes in contact with the coated region 11 as well on a principal surface (a corresponding one of 15 and 16) not coated with the active material-containing layer 3. In the coated region 11, the other one of the holding members 41 and 42 comes in contact with only a portion close to the uncoated region 12.

In each of the modifications described above, the pair of holding members 41 and 42 come in contact with the uncoated region 12 of the current collector 2 from the sides opposite to each other in the thickness direction of the belt-like member 1A, and hold the uncoated region 12 between them. Therefore, each modification achieves the same function and effect as those of the above-described embodiment and the like. That is, even if the width b of the uncoated region 12 increases, folding of the uncoated region 12 is adequately suppressed after the active material-containing layer 3 is rolled and the curve of the belt-like member 1A is corrected.

### (Verification Related to Embodiment)

Verification related to the above-described embodiment was conducted. The conducted verification will be explained below. In this verification, a belt-like member was formed by coating the surfaces of a current collector with active material-containing layers. An aluminum foil was used as the current collector. To coat the surfaces of the current collector, a slurry was prepared by suspending an active material, an electro-conductive agent, and binders in pure water. Niobium titanium oxide having a composition represented by TiNb₂O₇ was prepared as the active material. In addition, acetylene black (AB) was prepared as the electro-conductive agent, and carboxymethylcellulose (CMC) and styrene-butadiene rubber (SBR) were prepared as the binders. Then, TiNb₂O₇, AB, CMC, and SBR were put into pure water as a solvent and mixed at mixing ratios of 95 mass %, 2 mass %, 1.5 mass %, and 1.5 mass %, respectively. A slurry was obtained by dispersing the obtained mixture. The prepared slurry was applied on the surfaces of the current collector. More specifically, the slurry was not applied on one of the pair of long edges and its vicinity in the current collector. In the belt-like member, therefore, a coated region in which both of the pair of principal surfaces were coated with the active material-containing layers and an uncoated region in which neither of the pair of principal surfaces was coated with any active material-containing layer were formed. The uncoated region was formed in one of the pair of long edges and its vicinity in the current collector. Also, the uncoated region was formed to have a width b of 30 mm in the widthwise direction of the belt-like member.

In this verification, after the belt-like member was formed as described above, the active material-containing layer (slurry) formed on the surface of the current collector was dried. Then, the belt-like member was conveyed as described earlier in the embodiment and the like in a conveyance unit similar to that of the example shown in FIG. 3. Subsequently, the active material-containing layer in the conveyed belt-like member was rolled by a roll press by using a rolling unit similar to that of the example shown in FIG. 3. A press roller of the rolling unit was formed from die steel. Also, on the downstream side of the rolling unit, the belt-like member was pulled toward the downstream side by a pulling unit similar to that of the example shown in FIG. 3. This applied a tension in the longitudinal direction to the belt-like member between the pulling unit and the rolling unit. A pulling roller of the pulling unit was formed from rubber.

In the verification, a projection similar to the projection 37 was formed on the outer peripheral surface of a roller equivalent to the guide roller 27C of the example shown in FIG. 3. The projection and the roller on the outer peripheral surface of which the projection was formed were formed from stainless steel. Then, as described previously in the embodiment and the like, the uncoated region of the current collector of the belt-like member to which the tension was applied was pushed by the projection, thereby enlarging the uncoated region in the longitudinal direction. In this verification, on the downstream side of the roller where the uncoated region has been enlarged by the projection, the state of occurrence of folding in the uncoated region was observed. This observation of the occurrence state of folding in the uncoated region was performed under the conditions of Example 1, Example 2, and Comparative Example 1 to be explained below. Note that in Example 1, Example 2, and Comparative Example 1, the pressure (press pressure) for pushing the active material-containing layer in the rolling unit, the force of pulling the belt-like member toward the downstream side in the pulling unit, the projection for enlarging the uncoated region, and the like were the same.

In Example 1, a holding unit similar to the holding unit 24 described previously in the embodiment and the like was installed between the roller that has enlarged the uncoated region by the projection and the pulling unit. In this holding unit, a pair of holding members were formed from polyethylene. Also, in a case where a contact range within which the pair of holding members come in contact with the uncoated region, a dimension X of the contact range in the longitudinal direction of the belt-like member was set at one-fold (30 mm) of the width b of the uncoated region. In the holding unit, each holding member was brought into contact with the uncoated region in a nonrotatable state. Furthermore, each holding member was brought into contact with the uncoated region over the entire width of the uncoated region between the long edge and the coating end of the active material-containing layer.

The holding unit was installed between the roller that has enlarged the uncoated region by the projection and the pulling unit, in Example 2 as well. In Example 2, however, the dimension X of the contact range of the holding member in the longitudinal direction of the belt-like member was set at two-fold (60 mm) of the width b of the uncoated region. The conditions of Example 2 were the same as those of Example 1 except that the dimension X of the contact range was changed as described above. In Comparative Example 1, no holding unit was installed. That is, a pair of holding members were not installed.

In Comparative Example 1, folding occurred in the uncoated region at a position of 1 m on the downstream side from the roller that has enlarged the uncoated region. In Example 1, folding occurred in the uncoated region at a position of 200 m on the downstream side from the roller that has enlarged the uncoated region. In Example 2, no folding occurred in the uncoated region even at a position of 400 m on the downstream side from the roller that has enlarged the uncoated region.

The above verification demonstrates that after the active material-containing layer is rolled and the curve of the belt-like member is corrected, the occurrence of folding in the uncoated region is appropriately suppressed by holding the uncoated region between the pair of holding members. The verification also demonstrates that the occurrence of folding in the uncoated region is further appropriately suppressed by setting the dimension X of the contact range of the holding member in the longitudinal direction of the belt-like member at two-fold or more of the width b.

In at least one embodiment or example described above, a tension in the longitudinal direction is applied to the belt-like member between the rolling unit configured to roll the active material-containing layer and the pulling unit configured to pull the belt-like member. Then, between the rolling unit and the pulling unit, the pair of holding members are brought into contact with the uncoated region of the current collector from opposite sides in the thickness direction of the belt-like member, thereby holding the uncoated region between the pair of holding members. This makes it possible to provide a manufacturing method and a manufacturing apparatus of an electrode structure that properly suppress folding of the uncoated region after the active material-containing layer is rolled and the curve of the belt-like member is corrected, even if the width of the uncoated region increases.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. A manufacturing method of an electrode structure comprising:
conveying a belt-like member in which a surface of a current collector is coated with an active material-containing layer, and an uncoated region not coated with the active material-containing layer is formed in one of a pair of long edges along a longitudinal direction and a vicinity thereof in the current collector;
rolling the active material-containing layer in the conveyed belt-like member;
pulling the belt-like member toward a downstream side, on the downstream side of a rolling unit configured to roll the active material-containing layer, thereby applying a tension in the longitudinal direction to the belt-like member between a pulling unit configured to pull the belt-like member and the rolling unit; and
bringing, between the rolling unit and the pulling unit, a pair of holding members into contact with the uncoated region of the current collector from opposite sides in a thickness direction of the belt-like member to which the tension is applied, thereby holding the uncoated region between the pair of holding members.

2. The method according to claim 1, wherein in a case where a contact range within which the pair of holding members come in contact with the uncoated region of the current collector is defined, a dimension of the contact range in the longitudinal direction of the belt-like member is not less than twice a width of the uncoated region.

3. The method according to claim 1, wherein each of the pair of holding members comes in contact with the uncoated region of the current collector in a nonrotatable state.

4. The method according to claim 1, wherein each of the pair of holding members comes in contact with the uncoated region over an entire width between the one of the pair of long edges and a coating end of the active material-containing layer, in a widthwise direction of the belt-like member.

5. The method according to claim 1, wherein
the rolling unit pushes the active material-containing layer from both sides in the thickness direction of the belt-like member by sandwiching the active material-containing layer between a pair of press rollers, and
a material forming the holding members is softer than a material forming the press rollers.

6. The method according to claim 1, wherein
the pulling unit pulls the belt-like member to the downstream side in a state in which the belt-like member is sandwiched between a pair of pulling rollers, and
a friction coefficient of the holding members is smaller than that of the pulling rollers.

7. The method according to claim 1, further comprising pushing the uncoated region of the current collector against the belt-like member to which the tension is applied, by using a projection projecting toward an outer peripheral side in a roller between the rolling unit and the pair of holding members, thereby enlarging the uncoated region in the longitudinal direction.

8. The method according to claim 1, wherein in the coating the surface of the current collector with the active material-containing layer, the current collector is coated with the active material-containing layer such that a width of the uncoated region in a widthwise direction of the belt-like member is larger than 25 mm.

9. A manufacturing apparatus of electrode structure comprising:
a conveyance unit configured to convey a belt-like member in which a surface of a current collector is coated with an active material-containing layer, and an uncoated region not coated with the active material-containing layer is formed in one of a pair of long edges along a longitudinal direction and a vicinity thereof in the current collector;
a rolling unit configured to roll the active material-containing layer in the belt-like member conveyed in the conveyance unit;
a pulling unit configured to pull the belt-like member toward a downstream side, on the downstream side of the rolling unit, thereby applying a tension in the longitudinal direction to the belt-like member between the rolling unit and the pulling unit; and
a holding unit including a pair of holding members, installed between the rolling unit and the pulling unit, and configured to hold the uncoated region between the pair of holding members by bringing the pair of holding members into contact with the uncoated region of the current collector from opposite sides in a thickness direction of the belt-like member.
